(19) United States
(12) Patent Application Publication
(10) Pub. No.: US 2015/0203765 A1
(43) Pub. Date: Jul. 23, 2015

(54) Rubber Depolymerization And Related Processes

(71) Applicant: CH2E California LLC, Hudson, CO (US)

(72) Inventors: James Kostura, III, Denver, CO (US); Raymond F. Riek, Lake St. Louis, MO (US); Rudolf Arnold, Englewood, CO (US); Cynthia Caroline Hoppe, Superior, CO (US)

(21) Appl. No.: 14/565,858

(22) Filed: Dec. 10, 2014

Related U.S. Application Data
(60) Provisional application No. 61/915,728, filed on Dec. 13, 2013.

(51) Int. Cl. C10G 1/10; C09C 1/48

(52) U.S. Cl. CPC C10G 1/10; C09C 1/482

(57) ABSTRACT

A method for depolymerizing rubber tires. Rubber fuel may be pyrolyzed to produce a recovered carbon containing strands responsive to a magnet and vaporized rubber-derived compounds containing particulate material. The vaporized rubber-derived compounds containing particulate material may be passed through a cyclone to separate the particulate material from the vaporized rubber-derived compounds. The vaporized rubber-derived compounds may be contacted with a first liquid hydrocarbon material having a first boiling point to at least partially condense the vaporized rubber-derived compounds and produce a first liquid hydrocarbon product and a first residual vapor. The first liquid hydrocarbon product, the first residual vapor, and the recovered carbon may be separately recovered.

### RELATED APPLICATION

This application claims the benefit of U.S. Application Ser. No. 61/915,728, filed Dec. 13, 2013, and entitled TIRE DEPOLYMERIZATION AND RELATED PROCESSES, the entirety of which is incorporated herein by reference.

### BACKGROUND

1. Field

The present disclosure relates to a process for thermochemical decomposition of organic materials. In particular, the present disclosure relates to a process for pyrolysis of polymeric materials, especially depolymerization of rubber from tires, to produce liquid and gaseous hydrocarbons and recovered carbon. The disclosure also relates to a process for purification of the liquid hydrocarbons and to a process for converting the recovered carbon to activated carbon.

2. Description of Related Art

The handling and disposition of waste has changed with time. Whereas waste often had been discarded in landfills, for example, recycling and recovery have become important processes in waste management. Recycling and recovery can be environmentally-sensitive ways of dealing with waste products. In particular, paper, metal, and some plastics often are recycled or recovered rather than discarded. However, there are few suitable recycling or recovery processes available for rubber and rubber-containing products, such as tires.

Pyrolysis, i.e., thermochemical decomposition of organic materials at elevated temperature in an essentially oxygen-free atmosphere, has been used to convert waste and other materials to useful products. For example, medical waste, biomass, and other materials may be pyrolyzed. However, synthetic rubber and rubber-containing products are difficult to pyrolyze in an environmentally-sensitive way. In particular, car tires, which typically may contain about 80 percent synthetic rubber from petroleum products, may be difficult to pyrolyze.

The toughness and durability of synthetic rubber and tires containing synthetic rubber, for example, make environmentally-sensitive disposal difficult. For example, synthetic rubber does not degrade rapidly in a landfill, or when illegally dumped or abandoned. Further, essentially whole tires may serve as breeding grounds for vermin such as insects and rodents. Also, tires burn and release sooty, acrid smoke that pollutes the atmosphere. Tire fires are notoriously difficult to extinguish. Other ways of recycling rubber, such as re-treading of a tire, repurposing a tire as a swing or a barrier wall, or as filler for asphalt, are less than satisfactory and do not recover valuable products.

During the past approximately 25 years, the numbers of large above-ground tire piles and tire fires have decreased significantly, and governmental regulation and economic conditions likely may preclude development of more above-ground piles. About 70 percent of tires may go into a use that has little economic return, such as fill, rubber floor mats, crumb for athletic fields, landscaping mulch, and undifferentiated (and thus low-value) fuel stocks. The remainder may be landfilled after size reduction, as landfills no longer accept whole tires.

Pyrolysis of rubber, particularly tires, typically has not been successful at converting the waste to useful products in an environmentally-sensitive manner, or at an acceptable cost. Products typically are low-quality or low-value; neither is acceptable.

Therefore, there exists a need for a process that can recover useful products having quality and value from rubber and rubber-containing waste such as tires.

### SUMMARY

In one aspect, the disclosure provides a method for depolymerizing rubber, such as rubber of tires. Rubber fuel may be pyrolyzed to produce a recovered carbon containing strands responsive to a magnet and vaporized rubber-derived compounds containing particulate material. The vaporized rubber-derived compounds containing particulate material may be passed through a cyclone to separate the particulate material from the vaporized rubber-derived compounds. The vaporized rubber-derived compounds may be contacted with a first liquid hydrocarbon material having a first boiling point to at least partially condense the vaporized rubber-derived compounds and produce a first liquid hydrocarbon product and a first residual vapor. The first liquid hydrocarbon product, the first residual vapor, and the recovered carbon may be separately recovered.

In other aspects, the separation of particulates from vaporized rubber-derived compounds may be carried out in a different way.

In another aspect, the disclosure further provides a method for forming tire-based fuel. Tires first may be shredded to form a primary cut, and the primary cut may be shredded to form tire pieces. The tire pieces may be conditioned by cleaning, drying if necessary, and sizing to produce tire-based fuel.

In yet another aspect, the disclosure further provides for separate recovery of hydrogen and fuel gas. The first residual vapor may be desulfurized to produce sweet gas. Hydrogen may be separated from the sweet gas to produce fuel gas. The hydrogen and the fuel gas may be separately recovered.

In another aspect, the disclosure further provides for supplying heat to the rubber fuel by burning the fuel gas.

In still another aspect, the disclosure further provides for filtering and hydrotreating the first liquid hydrocarbon product. The first liquid hydrocarbon product may be filtered to produce a first filtered liquid hydrocarbon product. Filtration may include a centrifugation step. The first filtered liquid hydrocarbon product may be treated with hydrogen to desulfurize the first filtered liquid hydrocarbon product and saturate unsaturated hydrocarbons in the first filtered liquid hydrocarbon product to produce a first saturated liquid hydrocarbon product.

In another aspect, the first filtered hydrocarbon liquid may be treated by way of other processes to improve the quality or suitability for use.

In another aspect, the disclosure further provides for obtaining hydrogen from the first residual vapor for hydrotreating the first liquid hydrocarbon product. The first residual vapor may be desulfurized to produce sweet gas. Hydrogen then may be separately recovered from the sweet gas to produce a fuel gas. The first liquid hydrocarbon product may be filtered to produce a first filtered liquid hydrocarbon product. Filtration may include a centrifugation step. The first filtered liquid hydrocarbon product may be treated with the hydrogen to desulfurize the first filtered liquid hydrocarbon product and saturate unsaturated hydrocarbons in the first filtered liquid hydrocarbon product to produce a first saturated liquid hydrocarbon product.

In still another aspect, the disclosure further provides for conversion of the recovered carbon to activated carbon. The recovered carbon may be exposed to a magnet to remove the fibers responsive to a magnet, and then may be reacted with carbon dioxide to produce activated carbon and carbon monoxide. The activated carbon may be separately recovered.

In yet another aspect, the disclosure further provides for heating the recovered carbon by burning the carbon monoxide.

In another aspect, the recovered carbon may be converted to activated carbon by processing with steam using the water gas reaction.

In still another aspect, the disclosure provides for further processing of the recovered carbon to form carbon black.

Other systems, methods, features, and advantages of the present embodiments will be, or will become, apparent to one of ordinary skill in the art upon examination of the following figure(s) and detailed description. It is intended that all such additional systems, methods, features and advantages be included within this description and this summary, be within the scope of the disclosure, and be protected by the claims appended hereto, and by their equivalents.

### BRIEF DESCRIPTION OF THE DRAWINGS

The present embodiments can be better understood with reference to the following drawing(s) and description. The components in the figure(s) are not necessarily to scale, emphasis instead being placed upon illustrating the principles of the present embodiments. Moreover, in the figure(s), like reference numerals designate corresponding parts throughout the different views.

FIG. 1 is a schematic diagram of an embodiment of a system and method for recycling and recovering organic materials;

FIG. 2 is a schematic diagram of an embodiment of a system and method for converting recovered carbon to carbon black;

FIG. 3 is a schematic diagram of an embodiment of a system and method for liquefying and filtering rubber fuel; and

FIG. 4 is a schematic diagram of an embodiment of a system and method for recovering organic materials.

### DETAILED DESCRIPTION

The disclosure relates to a process for pyrolysis of organic materials. Pyrolysis is thermochemical decomposition of organic materials at elevated temperature in an essentially oxygen-free atmosphere. Many types of organic materials, such as medical waste, biomass, plastics, and rubber, may be pyrolyzed. For convenience, however, the process disclosed herein is described in detail with respect to pyrolysis of rubber, particularly to pyrolysis of rubber tires including synthetic rubber, and to pyrolysis of other rubber products, such as automotive belts, hoses, gaskets, and the like. Also, for convenience, the process will be described in detail with respect to a continuous process.

The disclosure provides a method for depolymerizing rubber tires. Rubber fuel may be pyrolyzed to produce a recovered carbon containing strands responsive to a magnet and vaporized rubber-derived compounds containing particulate material. The vaporized rubber-derived compounds containing particulate material may be passed through a cyclone to separate the particulate material from the vaporized rubber-derived compounds. The vaporized rubber-derived compounds may be contacted with a first liquid hydrocarbon material having a first boiling point to at least partially condense the vaporized rubber-derived compounds and produce a first liquid hydrocarbon product and a first residual vapor. The first liquid hydrocarbon product, the first residual vapor, and the recovered carbon may be separately recovered.

The disclosure further provides alternative methods for ensuring that particulates are not introduced into the gas and liquid products. For example, in some embodiments, particulate from the pyrolysis unit may be recovered as recovered carbon. In some embodiments, particulate may be recovered from the pyrolysis unit by limiting entrainment in pyrolysis unit effluent. In some embodiments, particulate may be recovered from the pyrolysis unit by use of a separation technique or device, such as a cyclone or a filter. In some embodiments, particulate may be recovered from a liquid product by filtration or centrifugation.

The disclosure also relates to additional features that may be used alone or in any combination. These features include preparation of rubber fuel, separate recovery of hydrogen and fuel gas from the first residual vapor, filtration and hydrotreatment of the first liquid hydrocarbon product, conversion of recovered carbon to activated carbon, and conversion of recovered carbon to carbon black.

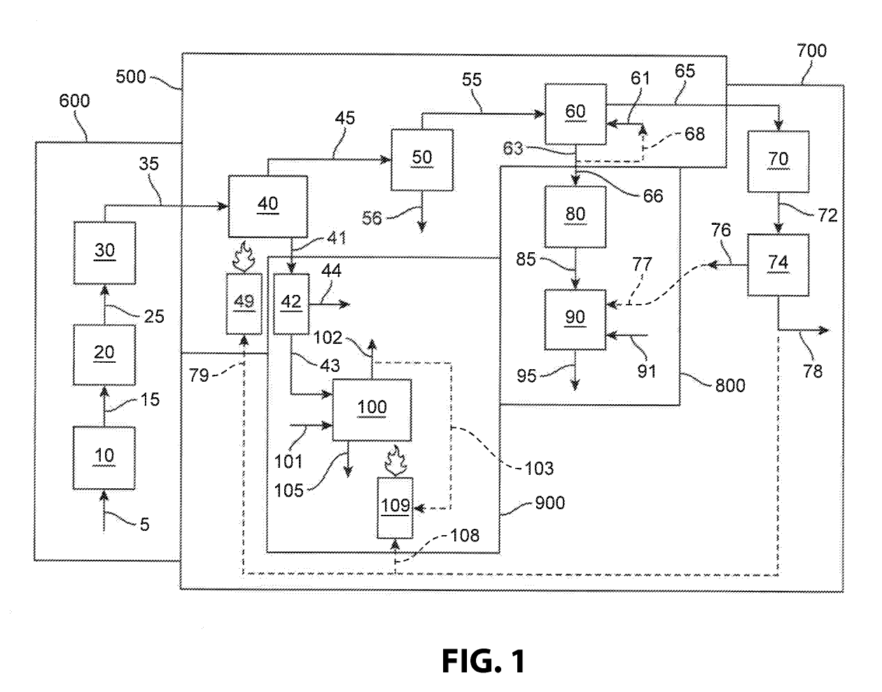

FIG. 1 is a schematic diagram of an embodiment of a system and method for recycling and recovering organic materials. FIG. 1 illustrates pyrolysis system 500, together with a section 600 for preparation of rubber fuel, a section 700 for separate recovery of hydrogen and fuel gas, a section 800 for filtration and hydrotreatment of liquid hydrocarbon product, and a section 900 for conversion of recovered carbon to activated carbon. The features described may be used alone or in any combination. Further, embodiments are not limited to what is shown on FIG. 1, but rather may include typical piping, conveying systems, heat exchange, pumps and blowers, stream recycle, and other features found in a system of this type, which are not and need not be described with specificity herein. Further, disclosure of an embodiment, such as a magnet, may include the presence of plural such embodiments, i.e., additional magnets, whether in series or in parallel.

FIG. 1 illustrates rubber fuel 35 as feed for pyrolysis unit 40. Pyrolysis unit 40 may include a sealed retort. The retort may be made of stainless steel or of any material that can withstand the temperature and compositions present. An auger, which also may be stainless steel or any other resistant material, may move the tire material through the retort. The retort may be indirectly heated by a low-emission burner 49. Waste products of combustion are not commingled with products of pyrolysis. Depolymerization of rubber in the retort includes an exothermic process that may provide at least part of the energy to drive the reaction. Therefore, only a portion of the energy required for the pyrolysis reaction need be obtained from an external source. Therefore, burner 49 may be used to heat the retort only when necessary.

In some embodiments, particularly after oxygen or air may have been admitted to the pyrolysis reactor, the first vapor evolved from the rubber may combine with the oxygen in the reactor in an energetic reaction and may burn. This burning will heat the tire pieces and increase the temperature in the reactor while improving safety by removing oxygen from the hydrocarbon stream. The energetic reaction also may improve the quality of the recovered carbon by removing additional hydrocarbon therefrom.

In some embodiments, rubber fuel 35 may include about 2 inch (nominal) pieces of tire. The rubber fuel preferably is clean, i.e., free from dirt and other debris, correctly sized, and dried, if necessary, to limit water contamination. Dirt introduced by the rubber fuel 35 may reduce the value of products of the pyrolysis system 500, particularly of the recovered carbon. Excess water requires additional energy in the pyrolysis reaction and in other steps of the process. Water also may emulsify with the hydrocarbon products in the scrubber tanks described below and may create waste in other steps. Such an emulsion may not be an acceptable product, but rather may be characterized as a waste product. In some embodiments, water may be separated from the hydrocarbon products using standard decanting, distillation, or other liquid/liquid separation methods.

In some embodiments, rubber fuel may be further reduced in size. A granulator may be used to reduce the size of the tire pieces or other rubber pieces to less than about 2 inches, typically from about 2 inches to about 0.5 inches. Smaller tire pieces may provide a cleaner feed. For example, reducing piece size to about 0.5 inches may provide the opportunity to remove more magnetizable metal that is the remnants of tire beads, belts, and plies. Additional size reduction may remove or make it easier to remove bits of magnetizable material by exposing more of the interior of the tire, thus disrupting pieces of metal. Small pieces also melt more quickly than larger pieces in the pyrolysis reactor. In some embodiments, the rubber pieces may be heated to a temperature at least about 700° F., typically at least about 600° F., more typically at least about 500° F., and even more typically at least about 400° F., before being introduced into the pyrolysis unit.

In some embodiments, the feed to the granulator may be dry, and may be sufficiently dry so as to be dusty. Therefore, in such embodiments, dust may be controlled by covering or completely enclosing the feed chute to the granulator. The feed chute may be an enclosed tunnel through which a conveyor can pass but which may avoid dust generation.

Smaller tire pieces also may provide the opportunity to remove fabric fluff, i.e., nylon and fibers that formed part of the tire. This fabric contaminant may be removed by vacuum or air flow sufficient to dislodge loose fabric pieces from the rubber pieces or in any suitable manner. These features are not shown on the figures, and may be located at many places in rubber fuel preparation system 600 or other embodiments thereof. Because fabric fluff, i.e., nylon fiber and other fabric fibers, has low density, such fabric fluff may be moved by way of slight air movement. Therefore, a slight air sweep may effectively remove loose nylon and other fibers. In some embodiments, vacuum sources may be placed advantageously within the rubber fuel preparation system to capture these low-density fibers. In some embodiments, a vacuum typically may be used because a vacuum may capture the fabric and remove it from the depolymerization system to a bag or other container, whereas a puff of air may not capture the fabric. In some embodiments, vacuum sources may be placed advantageously within the rubber fuel preparation system to capture these low-density fibers.

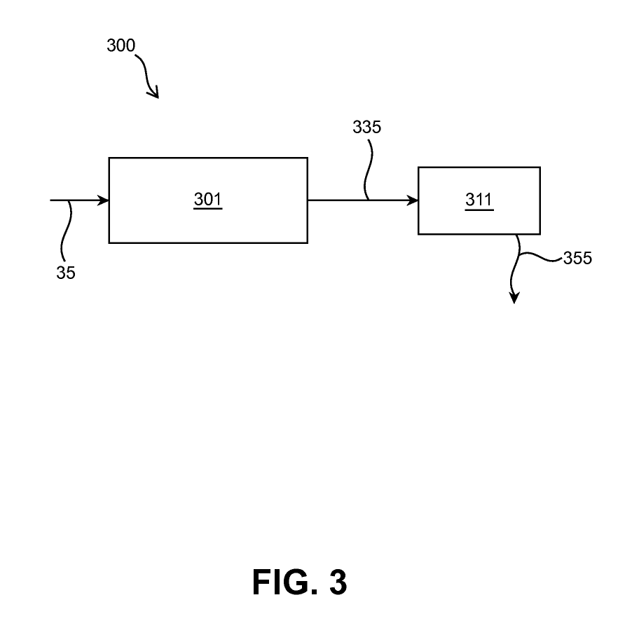

Turning now to FIG. 3, which illustrates an exemplary system and method 300 for liquefying and filtering rubber fuel, a rubber fuel 35 in the form of rubber pieces, which may have been reduced to a size of about 0.5 inches in some embodiments, may be introduced into extruder 301. Extruding the rubber pieces causes them to melt, producing molten rubber stream 335. Melting the feed stream may make it possible to use filter 311 through a screen. The screen may remove additional debris such as magnetizable materials, dirt and stones, and fabric fluff, thus improving operational reliability. Filtered rubber fuel is recovered at 355. In some embodiments, rubber fuel 35 in the form of rubber pieces may be heated in a heater (not shown) to provide a warmer feed and thus reduce the time and energy required to vaporize the rubber in pyrolysis unit 40 or 440, as further described below.

In embodiments of the disclosure, oxygen may be essentially precluded from the retort in pyrolysis unit 40. Oxygen in the retort typically reduces product yield, typically sweet gas yield or syngas product yield, and may produce other undesirable results. In some embodiments, oxygen may consume some of the syngas generated within the reactor and improve the rate at which energy is transferred to drive the reaction. Exclusion of oxygen may improve syngas yield, but inclusion of a minor amount of oxygen may improve throughput rate and economics of the process. To essentially exclude oxygen from the retort, a system of two knife gate valves may serve as an airlock on the feed port to the auger and the recovered carbon removal port from the auger. Any suitable oxygen exclusion system may be utilized for this purpose and the system may be run under vacuum. In some embodiments, air displaced in the reactor is replaced with an inert gas such as nitrogen.

In some embodiments, a small quantity of air may be introduced into the reactor with a batch of rubber fuel. This oxygen may cause or contribute to an energetic reaction as the rubber in the pyrolysis reactor begins to vaporize. This quick vaporization also may improve recovered carbon quality, and hence carbon black quality, by removing more hydrocarbon from the recovered carbon. The quick vaporization also may increase surface area by increasing the energy of the de-gassing process. This effect may increase as the pressure in the reactor decreases.

In embodiments, pyrolysis may be carried out at a retort temperature between about 700° F. and about 1300° F., typically between about 700° F. and about 900° F., more typically between about 750° F. and about 850° F., and even more typically between about 780° F. and about 820° F. In some embodiments, a flame front may develop and then self-extinguish for lack of oxygen when oxygen is exhausted. Then, heat may be introduced to maintain pyrolysis conditions. The temperature described herein is not the temperature of the rubber mass or of the vaporizing rubber leaving the reactor. Rather, the temperature range provided herein is that range measured in the reaction vessel, i.e., in the retort. Typically, the vaporized rubber-derived compounds containing particulate leaves the pyrolysis unit at a temperature of about 800° F.

In some embodiments, the pyrolysis unit may be operated at an absolute pressure of about 5 psi, typically at about 10 psi, and even more typically at a vacuum of between about 0.1 inches of water and about 3 inches of water, typically between about 0.1 inches of water and about 0.5 inches of water. Greater vacuum level may lead to introduction of air into the system through leaks in the system. Although the inventor does not wish to be bound by theory, it is believed that lower pressure in the reactor may cause early and faster gasification of the polymers in the rubber. This earlier production of hydrocarbon gas may reduce entrainment of recovered carbon and may improve the quality of the recovered carbon recovered by removing hydrocarbon from the surface of the recovered carbon as the result of this fast degasification.

In some embodiments, the pyrolysis unit may be operated at a slightly negative pressure, typically between about −0.5 inches of water and about −3.0 inches of water, more typically between about −1.0 inches of water and about −2.0 inches of water, to avoid leaks into the atmosphere. The rate at which rubber fuel 35 is moved through the retort in pyrolysis unit 40 to vaporize and char rubber fuel 35 at the described temperature and pressure conditions may be related to a feed rate at which heat may be transferred into the rubber feed in the retort. In some embodiments, the heat transfer rate may be sufficient to maintain a selected temperature in the retort.

Pyrolysis of rubber fuel 35 in the retort in pyrolysis unit 40 may produce a gaseous product and a solid product. The gaseous product may be vaporized rubber-derived compounds containing particulate material 45. The solid product may be a recovered carbon 41, which may include strands responsive to a magnet and about 15 wt percent ash. Ash may include many of the inorganic compounds from the tire, such as zinc oxide, titanium dioxide, and other fillers, and a fraction of the sulfur from the tire.

Recovered carbon and undecomposed particles of rubber and fiberglass from tire pieces may tend to leave pyrolysis unit 40 in the gaseous effluent. These particles may have a particle size of up to about 1000 microns and may clog piping and instrumentation. In some embodiments, the concentration of particles in reactor effluent 45 may be reduced by controlling the gas exit velocity. In some embodiments, a filter (not shown) may be employed on the retort gas effluent to capture recovered carbon particles from the effluent. Such a filter also may remove fabric fluff and other particulate material.

In some embodiments, vaporized rubber-derived compounds containing particulate material 45 may flow to cyclone 50. Particulate material 56 may be separated from vaporized rubber-derived compounds stream 55 in cyclone 50. Particulate material 56 may be recovered as carbon product. The resultant stream of vaporized rubber-derived compounds 55 then may be moved to scrubber tank 60. In scrubber tank 60, vaporized rubber-derived compounds 55 may be contacted with first liquid hydrocarbon material 61 to at least partially condense vaporized rubber-derived compounds 55 to yield first liquid hydrocarbon product 63 and first residual vapor 65. First liquid hydrocarbon material 61 has a first boiling point. The first boiling point affects the types and quantities of products recovered in the form of first liquid hydrocarbon product 63 and the first residual vapor 65. For example, if the boiling point is high, such as between about 550° F. and about 650° F., first liquid hydrocarbon product 63 may be a high-boiling liquid including liquid hydrocarbons having boiling points of between about 550° F. and about 650° F. and higher. Such a first liquid hydrocarbon product 63 may be considered to be a heavy fuel oil-type product, such as bunker fuel, because it may perform like such a heavy fuel oil. The skilled practitioner recognizes that such a product may require heating to retain fluidity and may involve difficulty in processing conditions and may require special apparatus.

The liquid hydrocarbon products herein are highly aromatic as compared with products in the same boiling range from natural crude oil. The quantity of first liquid hydrocarbon product 63 may be a relatively low portion of vaporized rubber-derived compounds 55, whereas the quantity of first residual vapor 65 may be a relatively larger portion of vaporized rubber-derived compounds 55. However, if the boiling point of first liquid hydrocarbon material 61 is lower, such as between about 350° F. and about 400° F., the relative quantity of first liquid hydrocarbon product 63 will increase, and the relative quantity of first residual vapor 65 will decrease. Such a first liquid hydrocarbon product 63 may be considered to be a combination of heavy fuel oil and diesel fuel; it may perform similarly to a combination of heavy fuel oil and diesel fuel from crude oil.

In some embodiments, liquid hydrocarbon products may be recovered as two or more streams. Recovery of two or more streams may be accomplished by processing the residual vapor from a previous step sequentially. For example, vapor stream 55 may be contacted with a first liquid hydrocarbon material 61 having a first boiling point to yield a heavy fuel oil-type product and a first residual vapor 65, as described above. Then, the first residual vapor may be contacted with a second liquid hydrocarbon material having a second boiling point lower than the first boiling point to yield a second liquid hydrocarbon product and a second residual vapor. For example, if the second boiling point is between about 350° F. and about 450° F., the second liquid hydrocarbon product may be considered to be a diesel fuel-type product. The second residual vapor then may be contacted with a third liquid hydrocarbon material having a third boiling point lower than the second boiling point to yield a third liquid hydrocarbon product stream. The third liquid hydrocarbon product may be considered to be a kerosene-type product.

In some embodiments, this third liquid hydrocarbon product has been found to be a strong solvent with potential application in oil-well stimulation and pipeline and tank cleaning.

Each of the liquid hydrocarbon product streams then may have a boiling point range roughly more than the first boiling point, between the boiling point range of the first boiling point and second boiling point, and between the second boiling point and the third boiling point, respectively. That is, if the first boiling point is 600° F., the second boiling point is 400° F., and the third boiling point is 250° F., the first liquid hydrocarbon product, which may be considered a heavy fuel oil-type product, would include compositions having boiling points greater than about 600° F., the second liquid hydrocarbon product, which may be considered to be a diesel fuel-type product, would include compositions having boiling points between about 600° F. and about 400° F., and the third liquid hydrocarbon product, which may be considered to be a kerosene-type product, would include compositions having boiling points less than about 250° F. This alternative technique is not shown in FIG. 1. However, with the guidance provided herein, the skilled practitioner would recognize how to obtain liquid hydrocarbon product streams having a selected boiling point range.

In some embodiments, at least part of liquid hydrocarbon material for a scrubber tank may be recycled liquid hydrocarbon product from that scrubber tank. As illustrated in FIG. 1, a fraction of first hydrocarbon product 63 may be recycled as first recycle stream 68 to form at least part of first liquid hydrocarbon material 61, while the remainder, first hydrocarbon product 66, may be recovered.

In some embodiments, first liquid hydrocarbon product 66 may be recovered and used as a heavy oil after filtration (not shown).

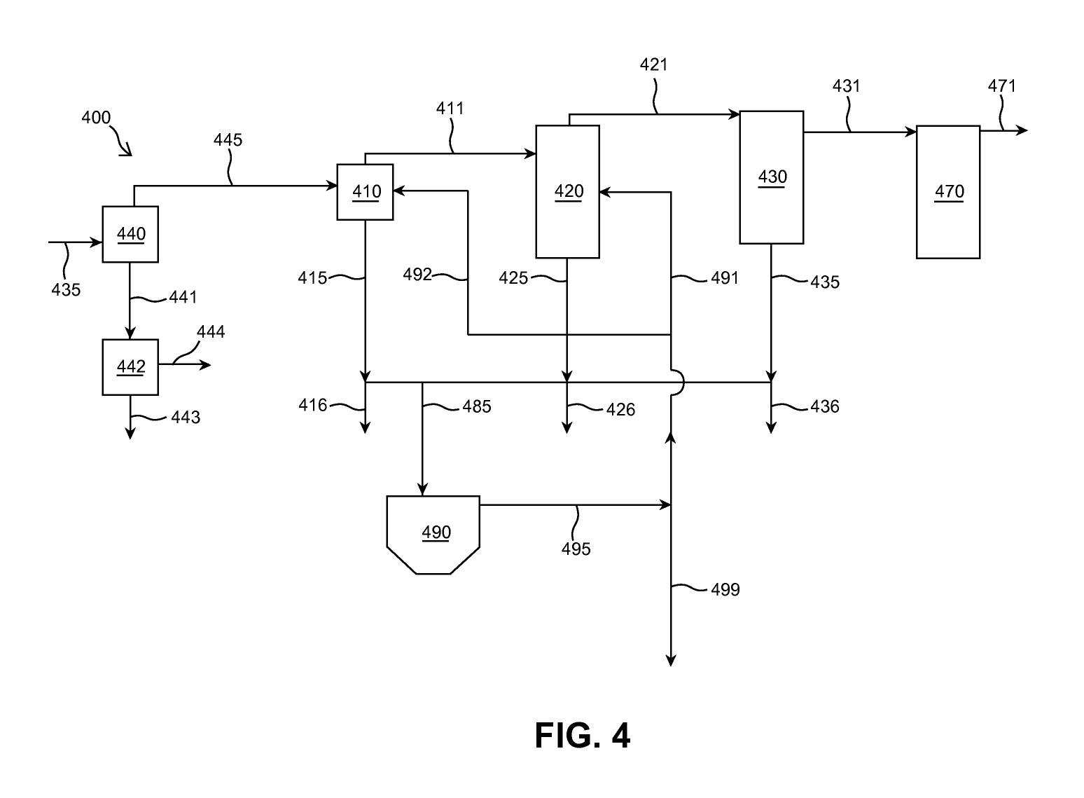

FIG. 4 illustrates another embodiment of the disclosure. As illustrated in FIG. 4, rubber fuel 435 may be fed into pyrolysis unit 440. Typically, rubber fuel 435 may be preheated or extruded and filtered before being fed into pyrolysis unit 440. Recovered carbon 441 may be passed near magnet 442, where clean recovered carbon 443 is recovered separately from magnetizable material 444.

In some embodiments, pyrolysis gas 445 may be directed to wash tank 410, into which first wash oil 492 also may be introduced. First wash oil 492 is a liquid hydrocarbon material that typically may be finished product 495 in some embodiments. Wash tank 410 may be maintained at a temperature that provides a selected partition or division of pyrolysis gas 445 into two streams. Wash tank 410 may be maintained at a temperature between about 225° F. and about 325° F., typically between about 250° F. and about 300° F.

Heavy liquid stream 415 is a first liquid hydrocarbon product that may be further finished in some embodiments and may be separately recovered as a heavy fuel oil-type liquid product 416. In other embodiments, heavy liquid stream 415 may be combined with bottom streams from other liquid processing steps and recovered as combined stream 485. This heavy liquid stream may comprise about 50 volume percent of the retort effluent and may be characterized as a fuel oil that is lighter than bunker fuel and heavier than diesel fuel.

First residual vapor 411 from wash tank 410 may flow to scrubber tank 420, which may be operated at a temperature between about 140° F. and about 220° F., typically between about 160° F. and about 200° F. Second wash oil 491 also may be introduced. Second wash oil 491, a liquid hydrocarbon, typically may be finished product 495 in some embodiments.

Intermediate liquid stream 425, a second liquid hydrocarbon product, may be further finished in some embodiments and may be separately recovered as intermediate liquid product 426. The product may be characterized as a diesel fuel-type product. In other embodiments, intermediate liquid stream 425 may be combined with bottom streams from other liquid processing steps and recovered as combined stream 485.

Second residual vapor 421 from scrubber tank 420 may flow to condenser 430, which may be operated at a temperature between about 70° F. and about 140° F., typically between about 80° F. and about 120° F. Condenser 430 may separate any remaining liquid, which may be further finished in some embodiments and may be separately recovered as light liquid product 436. In other embodiments, light liquid 435 may be combined with bottom streams from other liquid processing steps and recovered as combined stream 485.

In some embodiments, non-condensable gases 431 are separately recovered and desulfurized in desulfurizing unit 470 to produce sweet gas, syn gas, or product gas 471. Desulfurization unit 470 may use iron sponge or any other suitable desulfurization material or catalyst. Syn gas 471 may be used to provide heat to the pyrolysis unit or elsewhere, as needed.

Combined liquid product 485 may be delivered to centrifuge 490 for removal of any remaining contaminants. Finished product 495 may provide wash oil 492 and wash oil 491. In some embodiments, final product 495 is delivered as liquid product 499 to a product delivery and storage system.

Sulfur is present in a tire, typically because sulfur is used as a vulcanizing agent for rubber. During pyrolysis of vulcanized rubber, sulfur typically may be distributed equally into the three product streams, i.e., approximately equally distributed into the non-condensable gas, the liquid products, and the solid recovered carbon. Thus, the heavier liquid products, such as a heavy fuel oil-type product, may have a sulfur concentration of between about 1 wt percent and about 5 wt percent, typically between about 1 wt percent and about 4 wt percent, and more typically between about 1 wt percent and about 3 wt percent. These sulfur levels are significantly below the typical sulfur concentrations of at least about 4 wt percent sulfur in heavy fuel oil derived from crude oil. A light fuel oil-type product may have a sulfur concentration of between about 0.5 wt percent and about 1.5 wt percent, typically between about 0.6 wt percent and about 1.1 wt percent, and more typically between about 0.65 wt percent and about 0.8 wt percent. Similarly, a kerosene-type product may have a sulfur concentration of between about 0.1 wt percent and about 1.0 wt percent, typically between about 0.1 wt percent and about 0.6 wt percent, and more typically between about 0.1 wt percent and about 0.5 wt percent. The skilled practitioner recognizes that the sulfur concentration of the various products described herein may be related to the different boiling ranges. The sulfur that remains in the recovered carbon may improve performance of the carbon black in products.

Other embodiments may include additional processing steps that may be used together in any combination. For example, in some embodiments, the rubber fuel may be formed from tires. Tires first are shredded to form a primary cut, and the primary cut is shredded to form tire pieces. The tire pieces are conditioned by cleaning, drying if necessary, and sizing to produce rubber fuel.

As shown in section 600 of FIG. 1, tires 5 may be shredded in first shredder 10 to form primary cuts stream 15. For convenience, this section will be described as it relates to processing of tires. However, the disclosure also relates to processing of rubber from sources other than tires. Primary cuts stream 15 may include pieces of tire having a dimension of up to about 9 inches. Primary cuts stream 15 then may be shredded again in second shredder 20 to form tire pieces 25 having a dimension of up to about 2 inches. In some embodiments, first shredder 10 may be located above or on second shredder 20, so that the first shredder feeds directly into the second shredder. In some embodiments, other rubber articles also may be shredded in these shredders.

Second shredder 20 also may wash the pieces of tire to remove dirt and debris. In some embodiments, the blades of both shredders are cooled by spraying the blades with water. This water also washes dirt off the tire pieces and keeps dust down. The vertical arrangement of the shredders affords the opportunity to collect the wash water in a basin at the bottom of the second shredder. Thus, the collection tank serves as a catch basin for dirt and debris and as a collection tank from which water may be recycled. In some embodiments, either shredder may be bypassed, for example, for maintenance. In some embodiments, for example with rubber feeds comprising shredded rubber, both shredders may be bypassed.

Tire pieces 25 may be introduced to classifier and trommel 30, in which the tire pieces may be conditioned to yield tire-based fuel 35. Classifier and trommel 30 condition the tire pieces by sizing the tire pieces to ensure uniformity, knocking off residual dirt and debris, and, if necessary, by removing moisture to achieve a moisture level for rubber fuel set forth herein and produce tire-based fuel 35. A belt magnet may be placed between the classifier and the trommel to maximize the ability of the trommel to clean the tire pieces. In some embodiments, other rubber materials may be shredded as required or may be added to the tire-based fuel to form a rubber fuel.

In some embodiments, the wash trommel also may be modified to serve as a wash screen. Tires and rubber that are clean may not be washed again in the trommel. The wash water may be collected in a collection tank below the trommel. The collection tank serves as a catch basin for dirt and debris and as a collection tank from which water is recycled. The collection tank, which typically is disposed underneath and adjacent the trommel, may be lowered, i.e., moved away from the trommel, for cleaning and removal of dirt and debris therefrom. In some embodiments, conveyors and other transport mechanism for pieces of rubber fuel and any other solids, such as recovered carbon, carbon black, and activated carbon, may be covered for dust control.

In some embodiments, washing may be carried out on a vibrating screen. Such a screen vibrates in a manner that urges particles in a direction while separating the materials, with finer material falling through the screen while larger particles are urged down the screen.

A first portion of the screen, such as between about 20 percent and about 50 percent, typically between about 25 percent and about 33 percent, of the length of the screen in the direction the particles are urged, may be made of a screen-type material that has small openings intended to let dirt, debris, and water pass through, but retain essentially all tire pieces. Thus, the size of the openings is between about 1½ inches and about ¼ inch, typically between about 1 inch and about ¼ inch.

This first portion may have spray nozzles that spray water or other cleaning fluid onto tire pieces on the screen. The fluid washes dirt, steel, nylon, and other contaminants through the screen. Cleaned tire pieces are urged to travel the remainder of the length of the screen. Water that falls through the screen may be recycled after removal of at least part of the dirt, ferrous material, fabric, and other debris. The screen on the remainder of the table may be used to separate appropriately-sized tire pieces while retaining pieces that are too large. These large pieces are returned for additional size reduction. Thus, the size of this screen may range from about 3 inches to about 1 inch, typically from about 2½ inches to about 1¼ inches.

In some embodiments, another shredder may re-size cleaned tire pieces and other rubber materials to feedstock size. Feedstock size may be between about 2 inches and about ½ inch, typically between about 1¼ inches and ¾ inches.

In some embodiments, nylon and other fabric may be removed from the rubber feed with vacuums placed along the feed path, and typically from the infeed hopper of the sizing shredder. The nylon and fabric removed from the feed may be collected in bags, bins, or other convenient containers for disposal or further processing.

Both additional ferrous material and additional loose nylon and fabric may be removed after the sizing shredder. In some embodiments, a vibrating belt or shaker table may urge the feedstock in a direction. A plurality of belt magnets or drum magnets may remove loose ferrous material. In some embodiments, tire pieces removed by the magnets because they contain ferrous materials may be returned to the shredders for further processing. In some embodiments, additional vacuum sources may remove loose nylon and fabric before clean feedstock is collected for further processing.

Other embodiments of the disclosure further provide for separate recovery of hydrogen and fuel gas. The first residual vapor may be desulfurized to produce sweet gas. Hydrogen may be separated from the sweet gas to produce fuel gas. The hydrogen and the fuel gas may be separately recovered.

In some embodiments, first residual vapor 65 may be desulfurized in desulfurizer 70, as shown in section 700 of FIG. 1. Any suitable method for removing sulfur-containing compounds may be used. In some embodiments, sulfur may be removed by contacting first residual vapor 65 with iron sponge at a pressure between about 0.25 psi and about 3.0 psi, and typically between about 0.5 psi and about 2.0 psi, to form sweet gas 72 in desulfurizer 70. Contacting a sulfur-containing gas with iron sponge removes sulfur from the gas and increases the hydrogen content of the gas. Iron sponge is Fe₂O₃, often distributed across a supporting material.

In some embodiments, sweet gas 72 then may be delivered to pressure swing adsorption unit 74 to separate hydrogen 76 from fuel gas 78. Pressure swing adsorption unit 74 may include typical sorbents, such as zeolytes and activated carbon. Hydrogen 76 and fuel gas 78 may be separately recovered. Alternatively, hydrogen 76 and fuel gas 78 may be used elsewhere in the system.

In some embodiments, fuel gas 78 may be burned to supply heat to other units in the system, as represented by the dashed lines in FIG. 1. For example, in some embodiments, fuel gas 78 may be delivered as fuel gas 79 to pyrolysis burner 49. In some embodiments, fuel gas 78 may be delivered as fuel gas 108 to activated carbon burner 109. In other embodiments, fuel gas 78 may be delivered to both pyrolysis burner 49 and activated carbon burner 108, as illustrated in FIG. 1. Fuel gas 78 may be delivered to a burner in response to a demand.

In still other embodiments, a filtration and hydrotreatment system may provide for filtering and hydrotreating the first liquid hydrocarbon product. The first liquid hydrocarbon product may be filtered to produce a first filtered liquid hydrocarbon product. Filtration may include a centrifugation step. The first filtered liquid hydrocarbon product may be treated with hydrogen to desulfurize the first filtered liquid hydrocarbon product and saturate unsaturated hydrocarbons in the first filtered liquid hydrocarbon product to produce a first saturated liquid hydrocarbon product.

As shown in section 800 of FIG. 1, first liquid hydrocarbon product 66 may be delivered to filtration unit 80. Typically, the filtration unit 80 removes particles having a particle size greater than or equal to about 0.5 μm. Filtration unit 80 may include a centrifuge. A centrifuge may be used to separate first liquid hydrocarbon product 66 into an aqueous stream, a hydrocarbon stream, and a sludge stream. In embodiments, the aqueous stream may be discarded (not shown). In some embodiments, the sludge may be recycled to the pyrolysis unit for additional thermal decomposition (not shown).

In some embodiments, a centrifuge may be used to remove particles having a particle size greater than or equal to about 2 μm, and then a filter may be used to remove particles having a particle size greater than or equal to about 0.5 μm. Liquid temperature may be at least about 100° F., typically at least about 125° F., to lower the liquid viscosity and increase separation efficiency. In some embodiments, more than one filter may be present, with each successive filter after the first designed to retain smaller solids than the previous filter. Thus, in such embodiments, the first filter may have a nominal size of 25 μm, whereas the nominal size of the next filter in sequence may be 0.5 μm. Suitable filtration units are available from many commercial sources.

The hydrocarbon stream from filtration unit 80 is identified in FIG. 1 as first filtered liquid hydrocarbon product 85, which may be transported to first liquid hydrotreater 90. Hydrogen 91 may be infused into first filtered liquid hydrocarbon product 85 in first liquid hydrotreater 90 and the combination may be vaporized, then contacted with hydrotreating catalyst. Any hydrocarbon hydrotreating catalyst is suitable for use. In some embodiments, molybdenum/cobalt desulfurization catalyst is used.

In some embodiments, the reaction between hydrogen and first filtered liquid hydrocarbon product 85 in the presence of catalyst in first liquid hydrotreater 90 may not only saturate unsaturated compounds in first filtered liquid hydrocarbon product 85, but also may remove sulfur-containing compounds. The skilled practitioner recognizes that “unsaturation” refers to carbon—carbon bonds that are double or triple bonds. Such double bonds may be found in compounds including aromatic rings. In embodiments, the degree of saturation may be at least about 30 percent, typically at least about 40 percent, and more typically at least about 50 percent. In embodiments, the degree of sulfur reduction may be at least about 15 percent, typically at least about 25 percent, and more typically at least about 50 percent.

In embodiments, the gas may be cooled by heat exchange to recover first saturated liquid hydrocarbon product 95 from first liquid hydrotreater 90. Non-condensable gas may be desulfurized by flow through iron sponge catalyst to separate sulfur from hydrogen as described herein. The separately-recovered hydrogen may be used in a hydrotreating process.

In some embodiments, hydrogen from the first residual vapor may be used for hydrotreating the first liquid hydrocarbon product. The first residual vapor may be desulfurized to produce sweet gas. Hydrogen then may be separately recovered from the sweet gas to produce a fuel gas, as described herein. The first filtered liquid hydrocarbon product may be treated with the hydrogen to desulfurize the first filtered liquid hydrocarbon product and saturate unsaturated hydrocarbons in the first filtered liquid hydrocarbon product to produce a first saturated liquid hydrocarbon product.

As shown in FIG. 1, in some embodiments, hydrogen 76 from pressure swing adsorption unit 74 may be directed to first liquid hydrotreater 90, as shown at 77, to supply at least a part of the hydrogen used therein.

In some embodiments, recovered carbon may be converted to activated carbon. The recovered carbon may be exposed to a magnet to remove the strands responsive to a magnet. Such strands may be present as parts of steel belts, beads, and wire present in tire-based fuel. The recovered carbon then may be reacted with carbon dioxide to produce activated carbon and carbon monoxide. The activated carbon may be separately recovered.

As shown in section 900 of FIG. 1, recovered carbon 41, which may include strands responsive to a magnet, may be exposed to magnet 42. Magnet 42 removes magnet-responsive strands 44 from the recovered carbon stream to produce cleaned recovered carbon 43. Cleaned recovered carbon 43, which is the carbon fraction of recovered carbon 41, also may be known as carbon black, and may be sold after further processing or disposed of without further processing.

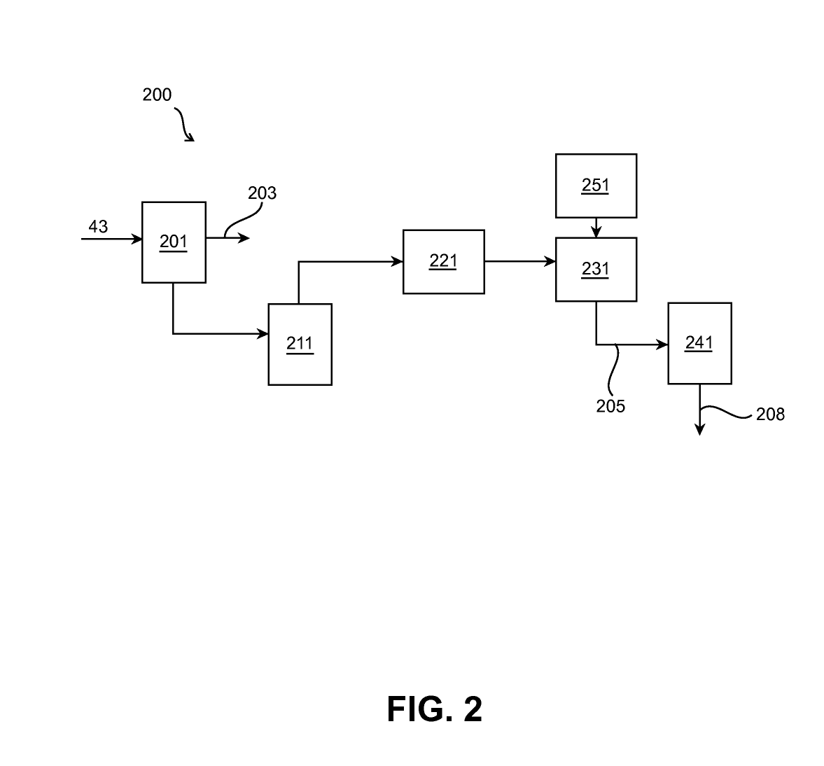

FIG. 2 shows a system 200 and method for converting recovered carbon to carbon black. In some embodiments, such as those illustrated in FIG. 2, cleaned recovered carbon 43, now free of magnetic components, may be transported to a vibrating screen 201 to separate any remaining textile fibers or cords 203 that remain.

Solid material fine enough to pass through the vibrating screen 201 may be identified as crude carbon black, which may be pulverized in pulverizer 211. Pulverizer 211 may include appropriate environmental protection by limiting fugitive carbon black. Particle size may be reduced to less than about 30 microns, typically less than about 25 microns, and more typically less than about 20 microns. In some embodiments, particle size is reduced to less than about 10 microns.

Carbon black in pulverizer 211 is blown out of pulverizer 211 and into mechanical air classifier 221. Particles from classifier 221 may be directed to agglomerator 231 in which the carbon black may be pelletized. Particles larger than suitable size described herein may be reprocessed. In some embodiments, carbon black may be pelletized by mixing the carbon black with a binder solution or water from agitated tank 251.

Carbon black exits the agglomerator 231 as pellets having a size of between about 10 mesh and about 100 mesh, and typically between about 18 mesh and about 60 mesh. The pellets 205 may be dried in dryer 241 until the moisture content is reduced to about 2 wt percent, typically less than about 1 wt percent. Dried pellets 208 may be screened, with undersized and oversized particles recycled, ground, or otherwise dealt with, as appropriate. Correctly-sized pellets may be ready for bagging.

Carbon black used in tires may be selected from many grades, depending on the purpose in the rubber. However, carbon black produced from pyrolysis of tires typically will comprise many if not all of these grades. Carbon black thus produced typically will also comprise sulfur. However, carbon black, particularly pelletized carbon black, may be valuable in other fields, including plastics and rubbers.

Carbon black is an important reinforcing filler used in rubber compounds, and the improvement in rubber properties is a function of the physical and chemical characteristics of carbon black. Important fundamental physical and chemical properties include aggregate size and shape (structure), particle size, surface activities, and porosity. Other non-fundamental properties include the physical form and residue. The physical form of carbon black (beads/pellets or powder) can affect the handling and mixing characteristics of carbon black and hence, rubber properties. Degree of dispersion also may be related to the mixing procedures and equipment used.

The shape and degree of branching of the carbon black aggregates is referred to as structure. The structure level of a carbon black ultimately may determine its effects on several important rubber properties. Increasing carbon black structure may increase modulus, hardness, and electrical conductivity, and may improve dispersibility of carbon black.

In some embodiments, cleaned recovered carbon 43 may be converted to activated carbon. As shown in FIG. 1, cleaned recovered carbon 43 may be introduced to carbon retort 100, together with heat from carbon retort burner 109 and carbon dioxide 101, to form activated carbon using a process well known to a skilled practitioner.

The primary reaction products of cleaned recovered carbon and carbon dioxide from carbon retort 100 may include activated carbon 105 and carbon monoxide 102, as can be seen on FIG. 1. Activated carbon 105 may have a specific surface area of at least about 700 m²/g. Typically activated carbon 105 may have a particle size between about 200 mesh and 1600 mesh, and more typically between about 325 mesh and 1200 mesh. Carbon monoxide stream 102 may be used as at least part of the fuel for heating carbon retort 100, as shown in recycle 103. Fuel gas 78 also may be delivered to carbon retort burner 109, as shown at 108.

This disclosure is directed generally to a core disclosure of a pyrolysis system including pyrolysis unit 40 that produces three product streams, specifically recovered carbon 41, first hydrocarbon product 66, and first residual vapor 65. Another embodiment of a product recovery section 400 of the disclosure is illustrated in FIG. 4. Recovered carbon 41, liquid product 499 (see FIG. 4), and non-condensable gasses 471 (see FIG. 4). Other features generally include preparation of rubber fuel 35; separate recovery of hydrogen and fuel gas from first residual vapor 65; filtration and hydrotreating of first liquid hydrocarbon product 66; and conversion of cleaned recovered carbon 43 to activated carbon 105 or to carbon black 205. As noted herein, features described may be used alone or in any combination. Process steps described herein relate to the processes that accept materials from other processes, the processes that provide materials to other processes, and the processes that can recycle materials. Examples of these include pyrolysis unit 40, which accepts fuel gas 78 from pressure swing adsorption unit 74, and the first liquid hydrotreater 90, which accepts hydrogen 76 from pressure swing adsorption unit 74. In embodiments, process needs may be supplied by another source and products may be delivered to another location. For example, fuel gas and hydrogen may be purchased from another source, or may be sold or discarded.

Further, the skilled practitioner recognizes that typical piping, conveyors, heat exchange, pumps and blowers, stream recycle, and other features typically found in the system of this type are not and need not be described with specificity herein.

While various embodiments of the present embodiments have been described, the description is intended to be exemplary, rather than limiting and it will be apparent to those of ordinary skill in the art that many more embodiments and implementations are possible. For example, product boiling points may be changed to provide products having properties and characteristics requested by a purchaser. Accordingly, the present embodiments are not to be restricted except in light of the attached claims and their equivalents. Also, various modifications and changes may be made within the scope of the attached claims.

What is claimed is:

1. A method for depolymerizing rubber, the method comprising:
pyrolyzing rubber fuel in a pyrolysis unit to produce a recovered carbon containing strands responsive to a magnet and vaporized rubber-derived compounds containing particulate material;
separately recovering the recovered carbon containing strands responsive to a magnet and the vaporized rubber-derived compounds containing particulate material;
passing the vaporized rubber-derived compounds containing particulate material through a cyclone to separate the particulate material from the vaporized rubber-derived compounds;
contacting the vaporized rubber-derived compounds with a first liquid hydrocarbon material having a first boiling point to at least partially condense the vaporized rubber-derived compounds and produce a first liquid hydrocarbon product and a first residual vapor; and
separately recovering the first liquid hydrocarbon product and the first residual vapor.

2. The method of claim 1, further comprising:
shredding rubber to form a primary cut;
shredding the primary cut to form rubber pieces; and
conditioning the rubber pieces to produce the rubber fuel.

3. The method of claim 1, further comprising:
desulfurizing the first residual vapor to produce sweet gas;
separating hydrogen from the sweet gas to produce a fuel gas; and
separately recovering the hydrogen and the fuel gas.

4. The method of claim 3, further comprising:
supplying heat to the rubber fuel in the pyrolysis unit by burning at least part of the fuel gas.

5. The method of claim 1, further comprising:
heating the rubber fuel to a temperature at least about 700° F. before the rubber fuel is introduced into the pyrolysis unit.

6. The method of claim 1, further comprising:
exposing the recovered carbon to a magnet to remove the strands to form cleaned recovered carbon;
removing fabric fluff and screening the cleaned recovered carbon to separately recover crude carbon black;
pulverizing the crude carbon black to a particle size less than about 30 microns to form pulverized carbon black; and
agglomerating the pulverized carbon black to form pellets having a size of between about 10 mesh and about 100 mesh.

7. The method of claim 4, further comprising:
exposing the recovered carbon to a magnet to remove the strands to form cleaned recovered carbon;
removing fabric fluff and screening the cleaned recovered carbon to separately recover crude carbon black;
pulverizing the crude carbon black to a particle size less than about 30 microns to form pulverized carbon black; and
agglomerating the pulverized carbon black to form pellets having a size of between about 10 mesh and about 100 mesh.

8. A method for depolymerizing rubber, the method comprising:
pyrolyzing rubber fuel in a pyrolysis unit to produce a recovered carbon containing strands responsive to a magnet and vaporized rubber-derived compounds;
separately recovering the recovered carbon containing strands responsive to a magnet and the vaporized rubber-derived compounds;
contacting the vaporized rubber-derived compounds with a first liquid hydrocarbon material having a first boiling point to at least partially condense the vaporized rubber-derived compounds and produce a first liquid hydrocarbon product and a first residual vapor; and
separately recovering the first liquid hydrocarbon product and the first residual vapor.

9. The method of claim 8, further comprising:
heating the rubber fuel to a temperature at least about 700° F. before the rubber fuel is introduced into the pyrolysis unit.

10. The method of claim 8, further comprising:
shredding rubber pieces to a size of less than about 2 inches;
extruding the rubber pieces to form liquid rubber;
filtering the liquid rubber to remove metal strands and fabric fluff from the liquid rubber to form filtered rubber fuel; and
feeding the filtered rubber fuel into the pyrolysis unit.

11. The method of claim 8, further comprising:
exposing the recovered carbon to a magnet to remove the strands to form cleaned recovered carbon;
removing fabric fluff and screening the cleaned recovered carbon to separately recover crude carbon black;
pulverizing the crude carbon black to a particle size less than about 30 microns to form pulverized carbon black; and
agglomerating the pulverized carbon black to form pellets having a size of between about 10 mesh and about 100 mesh.

12. The method of claim 10, further comprising:
exposing the recovered carbon to a magnet to remove the strands to form cleaned recovered carbon;
removing fabric fluff and screening the cleaned recovered carbon to separately recover crude carbon black;
pulverizing the crude carbon black to a particle size less than about 30 microns to form pulverized carbon black; and
agglomerating the pulverized carbon black to form pellets having a size of between about 10 mesh and about 100 mesh.

13. The method of claim 8, further comprising:
removing recovered carbon, fabric fluff, and particulate material from the separately-recovered vaporized rubber-derived compounds by screening the separately-recovered vaporized rubber-derived compounds.

14. The method of claim 9, further comprising:
removing fabric fluff and particulate material from the separately-recovered vaporized rubber-derived compounds by screening the separately-recovered vaporized rubber-derived compounds.

15. The method of claim 11, further comprising:
removing fabric fluff and particulate material from the separately-recovered vaporized rubber-derived compounds by screening the separately-recovered vaporized rubber-derived compounds.

16. The method of claim 8, further comprising:
removing debris from the first liquid hydrocarbon product by filtering the first liquid hydrocarbon product.

17. The method of claim 10, further comprising:
removing debris from the first liquid hydrocarbon product by filtering the first liquid hydrocarbon product.

18. The method of claim 12, further comprising:
removing debris from the first liquid hydrocarbon product by filtering the first liquid hydrocarbon product.

19. The method of claim 8, further comprising:
removing debris from a liquid hydrocarbon product by centrifuging the liquid hydrocarbon product.

20. The method of claim 10, further comprising:
removing debris from a liquid hydrocarbon product by centrifuging the liquid hydrocarbon product.
